(19) United States
(12) Patent Application Publication
(10) Pub. No.: US 2015/0207454 A1
(43) Pub. Date: Jul. 23, 2015

(54) Photovoltaic Collector System Utilizing Inflatable Tubing

(71) Applicant: Edwin Earl Huling, III, Bethesda, MD (US)

(72) Inventor: Edwin Earl Huling, III, Bethesda, MD (US)

(21) Appl. No.: 14/594,033

(22) Filed: Jan. 9, 2015

Related U.S. Application Data
(60) Provisional application No. 61/925,452, filed on Jan. 9, 2014.

(51) Int. Cl. H02S 30/20; H02S 40/22

(52) U.S. Cl. CPC H02S 30/20; H02S 40/22

(57) ABSTRACT

A photovoltaic collector system utilizes inflatable tubing as a non-conventional mounting system. A photovoltaic means is connected to the outer surface of one or more inflatable tubes which are kept pressurized through a tube pressurization system. The inflatable tubes may be rotated with a tube rotation system in order to position the photovoltaic means at an advantageous angle relative to the sun for efficiently collecting sunlight for electricity generation.

The current application claims a priority to the U.S. Provisional Patent application Ser. No. 61/925,452 filed on Jan. 9, 2015.

### FIELD OF THE INVENTION

The present invention relates generally to renewable energy systems, particularly photovoltaic systems. More specifically, the present invention is a photovoltaic system utilizing flexible photovoltaic electrical generation means mounted to an inflatable cylinder.

### BACKGROUND OF THE INVENTION

The rapid growth of the Earth's population has led to a corresponding increase in the demand for energy. Because many power systems rely on the combustion of fossil fuels, greenhouse gas emissions have resulted in depletion of the Earth's ozone as well as global warming. Fossil fuels are a nonrenewable energy source and the rapid consumption of these ultimately limited resources has increased efforts to replace nonrenewable energy systems with renewable energy systems. Among renewable energy systems, solar power is a growing field in both small and large applications. Solar power systems maintain a high level of reliability reflected by the consistent rising and setting of the Sun. Additionally, solar power is attractive due to the costs saved over the lifetime of a solar power system. There are generally few recurring costs such as maintenance fees associated with solar power systems. Solar power systems generally comprise a plurality of solar panels with photovoltaic cells that absorb and convert sunlight into electricity. The solar panels typically require a mounting surface that is then anchored to a roof or the ground. Solar panels are available in fixed or adjustable configurations. Fixed solar panels are convenient as the panels may simply be installed and left alone. However, adjustable solar panels offer a higher energy yield as it is possible to optimize the tilt angle of the solar panels to capture the maximum amount of energy. Adjustable solar panels may be adjusted seasonally or daily as required. The present invention seeks to reduce the cost of photovoltaic energy systems by reducing the materials required currently for conventional panels and support structures, and by simplifying the means of tracking the sun to optimize collection efficiency.

The present invention is a photovoltaic system that forgoes the traditional means of mounting solar panels and the traditional means of moving solar panels to track the sun. Traditional mounting means typically require aluminum and glass panels mounted on a steel frame anchored to the ground via a concrete foundation. These materials are expensive and energy intensive to fabricate. In the preferred embodiment of the present invention, the photovoltaic system comprises a plurality of cylindrical inflated tubes. Each inflated tube comprises a flexible membrane with a plurality of flexible photovoltaic cells that is mounted to the inflated tube. The tube is inflated via two fans mounted to an inlet on each end of the tube. These fans are individually or jointly activated when internal air pressure drops below acceptable levels. Each inlet comprises a one-way valve to minimize leakage of air when air pressure reaches the proper level and fan(s) are turned off to conserve energy. The inflated tube may be mounted to a roof surface, the ground, or other surface via an anchor. In the preferred embodiment of the present invention, the inflated tubes of the photovoltaic system are mounted in a parallel arrangement. The photovoltaic system further comprises a drive system for adjusting the tilt angle of the photovoltaic cells seasonally or daily. The drive system comprises two sets of motors, drive rods, and a plurality of cables. The cables are attached to the inflated tubes of the photovoltaic system and are capable of rotating the inflated tubes to alter the tilt angle of the photovoltaic cells. In the preferred embodiment of the present invention, the drive system comprises two sets of cables with each set of cables mounted opposite the other. This allows the motors and drive rods to draw each set of cables attached to the inflated tubes in opposite directions, allowing rotation of the inflated tubes.

### BRIEF DESCRIPTION OF THE DRAWINGS

FIG. 1 is an environmental perspective view of one embodiment of the present invention.

FIG. 2 is an environmental perspective view of another embodiment of the present invention.

FIG. 3 is an interior detail view of one of the inflatable tubes.

FIG. 4 is a detail view of one of the inflatable tubes.

FIG. 5 is a side sectional view of one of the inflatable tubes showing the attachment of the drive cables to the tube.

FIG. 6 is a side sectional view of one of the inflatable tubes showing the attachment of the drive cables to the tube and rotation of the tube to account for changed sunlight angle relative to FIG. 6.

FIG. 7 is a perspective view of another embodiment of the present invention showing the anchors, straps, and surface covers.

FIG. 8 is a block diagram of the electronic components of the present invention.

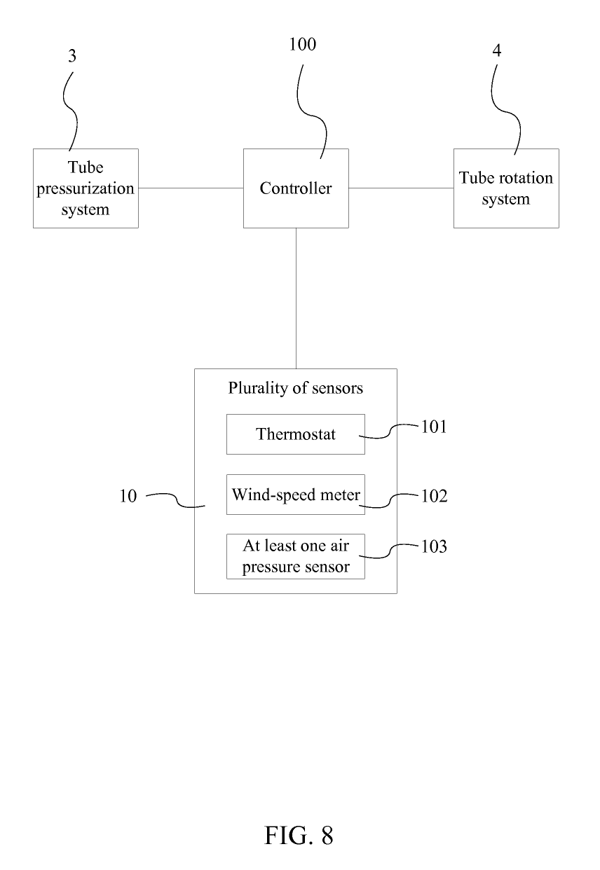

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced without the implementation of some features as they are described. It should be understood that some details have not been described in detail in order to not unnecessarily obscure focus of the invention.

The present invention is a photovoltaic energy system with a non-conventional mounting system. The photovoltaic system generally comprises a plurality of inflatable tubes to which photovoltaic cells are applied and utilizes a drive system to rotate the inflatable tubes and a pressurization system 3 to inflate the tubes and control the pressure within the tubes. The photovoltaic system is adjustable seasonally or daily in order to optimize the tilt angle of the photovoltaic cells and maximize sunlight absorption.

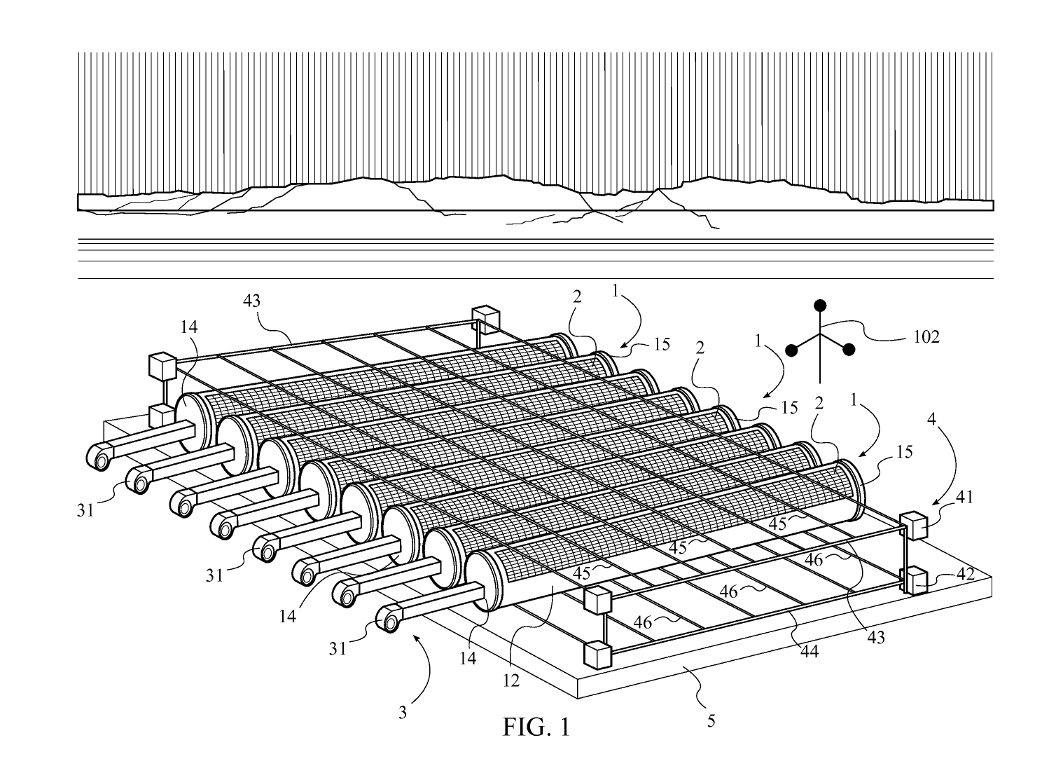

Referring to FIG. 1, the preferred embodiment of the present invention comprises at least one inflatable tube 1, a photovoltaic means 2, a tube pressurization system 3, a tube rotation system 4, a plurality of sensors 10, and a controller 100. The preferred embodiment of the present invention comprises a plurality of inflatable tubes 1, though a single inflatable tube 1 would accomplish the same goal to a lesser degree. In this embodiment, the plurality of inflatable tubes 1 is arranged parallel to each other in an array. The tube pressurization system 3 is operatively connected to each of the at least one inflatable tube 1 in order to supply the interior volume 13 of each of the at least one inflatable tube 1 with air pressure.

Each of the at least one inflatable tube 1 are generally cylindrical and may vary in diameter and length based on the requirements of individual applications. Furthermore, the at least one inflatable tubes 1 are not limited with respect to specific material. However, in the preferred embodiment of the present invention, the inflatable tubes 1 are composed of a flexible, durable material such as, but not limited to, reinforced polyethylene.

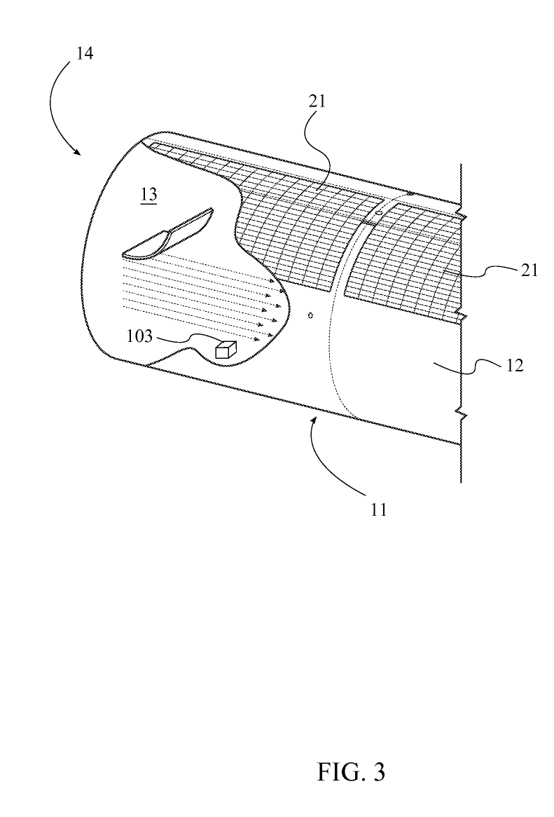

Referring to FIG. 3, each of the at least one inflatable tube 1 comprises an outer surface 11, a lateral portion 12, an interior volume 13, a first end 14, and a second end 15. To be specific, the lateral portion 12 refers to the cylindrical wall of the at least one inflatable tube 1 encountered by traveling perpendicular to the axis of the tube. The first end 14 and the second end 15 are positioned axially opposite each other along the lateral portion 12, i.e. along the axis of the tube. The interior volume 13 is encapsulated by the lateral portion 12, the first end 14 and the second end 15.

The photovoltaic means 2 is externally positioned about an exposure arc length 22 of the lateral portion 12. The exposure arc length 22 is an arbitrary portion of the lateral portion 12 desired to be exposed to sunlight.

The photovoltaic means 2 may be of any relevant technology for producing electricity in response to incident electromagnetic radiation, particularly visible light such as sunlight. The photovoltaic means 2 may be a plurality of photovoltaic cells, or the photovoltaic means 2 may take the form of microscopic particles or nanoparticles suspended in a delivery medium, or any other useful photovoltaic technology. The photovoltaic means 2 may also be known as solar cells. The photovoltaic means 2 is connected to the lateral portion 12 of the outer surface 11 along the exposure arc length 22. In one embodiment of the present invention, the photovoltaic means 2 comprises a plurality of flexible photovoltaic panels 21, as shown in FIG. 3. In this case, each of the plurality of flexible photovoltaic panels 21 is pre-manufactured and assembled prior to application to the at least one flexible tube. Utilizing these flexible photovoltaic panels 21 is a somewhat costly and time-intensive process, requiring a substrate, adhesive and the labor for applying them to the inflatable tube 1.

In another embodiment, the photovoltaic means 2 is applied directly onto the at least one flexible tube without necessitating prior assembly of photovoltaic panels. In this embodiment, the photovoltaic means 2 is made as an integral part of the flexible tube, utilizing means such as, but not limited to, 3-d printing photovoltaic cells onto the outer surface 11, spraying or brushing the photovoltaic cells onto the outer surface 11 from an ink-like reservoir, or another photovoltaic cell application technology.

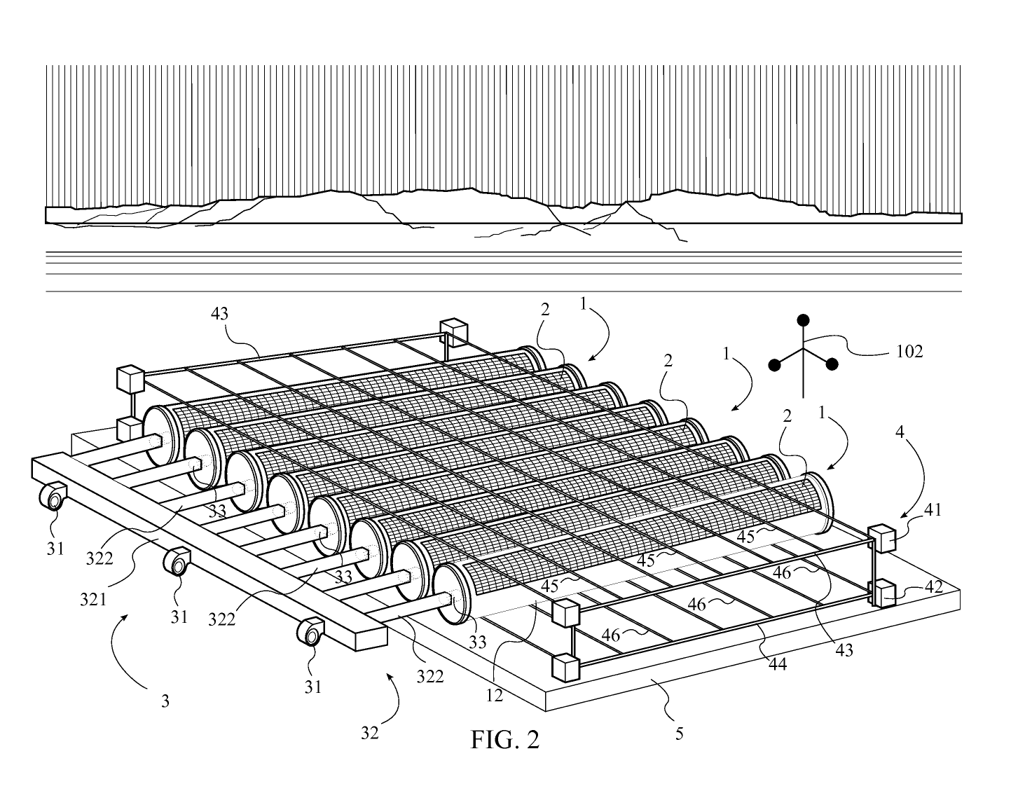

Referring to FIGS. 1-2, the present invention requires a tube pressurization system 3 to operate effectively. The tube pressurization system 3 is required to maintain air pressure within each of the at least one inflatable tube 1 in order to support the photovoltaic means 2. The tube pressurization system 3 comprises at least one air blower 31. The at least one air blower 31 may be of any type of machine that moves air with sufficient force and volume to maintain proper pressurization within the at least one inflatable tube 1.

The tube pressurization system 3 may be one of multiple configurations. One embodiment of the present invention shown in FIG. 2 utilizes a manifold to maintain uniform pressure within each of the at least one inflatable tube 1. In this embodiment, the tube pressurization system 3 further comprises a duct manifold 32 comprising a primary manifold duct 321 and at least one tube connection 322 duct. Each of the at least one air blower 31 is connected to the duct manifold 32, wherein the at least one air blower 31 pressurizes the duct manifold 32 by blowing air into the duct manifold 32. The duct manifold 32 should be sufficiently sealed to properly maintain air pressure within the duct manifold 32. Each of the at least one tube connection 322 duct is ductedly connected to the duct manifold 32 and in fluid communication with the primary manifold duct 321. Each of the at least one tube connection 322 duct are ductedly connected to and in fluid communication with one of the at least one inflatable tube 1. The air blower 31 supplies air pressure to the primary manifold duct 321 and thus to each of the at least one tube connection 322 duct and each of the at least one inflatable tube 1. In this embodiment, it is desirable to have multiple air blowers 31 connected to the duct manifold 32 in order to provide consistency and redundancy across the entire duct manifold 32.

In another embodiment shown in FIG. 1, each of the at least one inflatable tube 1 has its own air blower 31—each of the at least one air blower 31 is ductedly connected to and is in fluid communication with one of the at least one inflatable tube 1.

Additionally, at least one one-way air valve 33 is comprised. Each of the at least one one-way air valve 33 is connected between the tube pressurization system 3 and one of the at least one inflatable tube 1 in order to only allow air to enter the interior volume 13 while preventing air from leaving the interior volume 13 through the tube pressurization system 3. Any connection between the tube pressurization system 3 and the at least one inflatable tube 1 should be able to accommodate a certain amount of rotation. This may be accomplished through rotational seals or through the connection point being made of flexible tubing which can be twisted without compromising the integrity or functionality of the system.

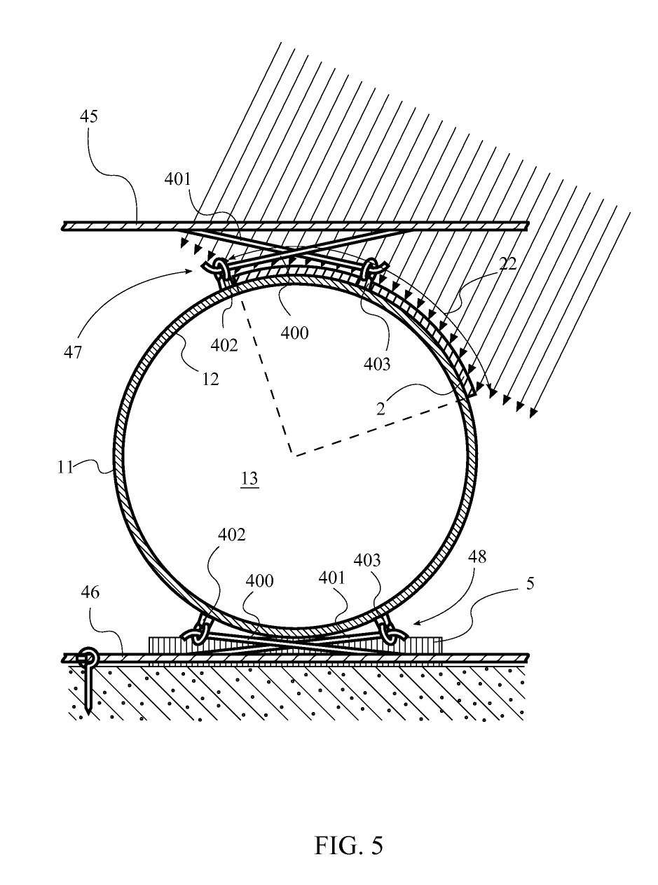

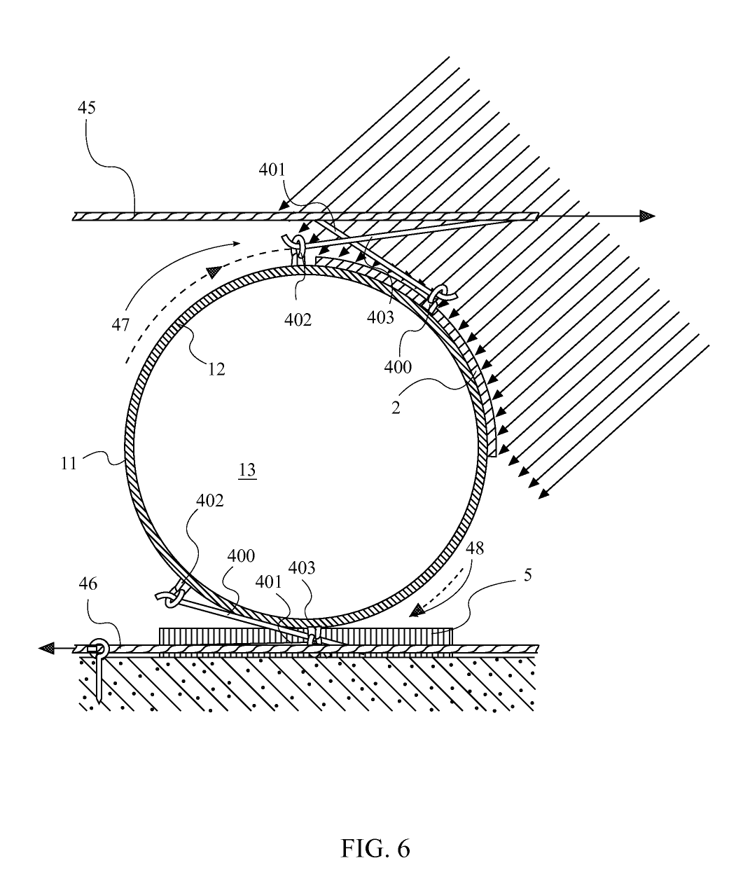

The preferred embodiment of the present invention further comprises a tube rotation system 4. The tube rotation system 4 is connected to the outer surface 11 of each of the at least one inflatable tube 1 and allows each of the at least one flexible tube to be rotated axially in order to expose the photovoltaic means 2 to sunlight in the most direct, efficient manner according to daily or seasonal changes in sun position. The rotation functionality is illustrated in FIGS. 5-6.

In the preferred embodiment, the tube rotation system 4 utilizes spooled cables connected to the at least one inflatable tube 1 which apply a torque to the at least one inflatable tube 1 in order to produce axial rotation. In alternate embodiments, it is possible that other types of tube rotation system 4 may be utilized, such as, but not limited to, motors placed at the first end 14 and/or second end 15 of each of the at least one inflatable tube 1 which apply torque to the ends of the tube, or treadmill-like devices placed underneath the tubes.

As shown in FIGS. 1-2, the tube rotation system 4 of the preferred embodiment comprises a first motor 41, a second motor 42, a first drive rod pair 43, a second drive rod pair 44, a first plurality of drive cables 45, and a second plurality of drive cables 46.

The first plurality of drive cables 45 is spooled between the drive rods of the first drive rod pair 43. Similarly, the second plurality of drive cables 46 is spooled between the drive rods of the second drive rod pair 44. The first motor 41 is operatively connected to the first drive rod pair 43 such that the first motor 41 axially rotates one of the drive rods of the first drive rod pair 43. The specific drive rod of the first drive rod pair 43 the first motor 41 turns is inconsequential, as turning either one of the drive rods results in both drive rods turning due to the first plurality of drive cables 45 being spooled between the first drive rod pair 43. Similarly, the second motor 42 is operatively connected to the second drive rod pair 44 such that the second motor 42 axially rotates one of the drive rods of the second drive rod pair 44.

The drive cables and drive rods are positioned around the at least one inflatable tube 1, forming a generally rectangular boundary around the at least one inflatable tube 1. The at least one inflatable tune is positioned vertically between the first plurality of drive cables 45 and the second plurality of drive cables 46. The first plurality of drive cables 45 are positioned above the at least one inflatable tube 1, and the second plurality of drive cables 46 is positioned below the at least one inflatable tube 1. This allows equal force to be applied at opposite locations of the at least one inflatable tube 1, with the first plurality of drive cables 45 and the second plurality of drive cables 46 moving in opposite directions in order to create a balanced net torque on the at least one inflatable tube 1. Additionally, the first plurality of drive cables 45 and the second plurality of drive cables 46 should be equally spaced out along the lateral portion 12 of each of the at least one inflatable tube 1 in order to equally distribute rotational force along the at least one inflatable tube 1.

Furthermore, the at least one inflatable tube 1 is positioned horizontally between the drive rods of the first drive rod pair 43 and the drive rods of the second drive rod pair 44. The first drive rod pair 43 and the second drive rod pair 44 are oriented parallel to each of the at least one inflatable tube 1. Each of the first plurality of drive cables 45 is externally connected to the lateral portion 12 of one of the at least one inflatable tube 1, and each of the second plurality of drive cables 46 is externally connected to the lateral portion 12 of one of the inflatable tubes 1 laterally opposite one of the first plurality of drive cables 45. Each of the first plurality of drive cables 45 should be connected to each of the at least one inflatable tube 1 at or close to 180 degrees around the outer surface 11 from one of the second plurality of drive cables 46. The first plurality of drive cables 45 and the second plurality of drive cables 46 should be oriented perpendicular and tangent to each of the at least one inflatable tube 1.

In the preferred embodiment of the present invention, the drive cables of the tube rotation system 4 are connected to the outer surface 11 of the inflatable tubes 1 by grommets which are equally distributed axially along the lateral surface at the same interval as the drive cables. More particularly, the tube rotation system 4 comprises a first plurality of grommet sets 47 and a second plurality of grommet sets 48, as shown in FIG. 5. Each of the first plurality of grommet sets 47 are connected to the outer surface 11 of one of the inflatable tubes 1, and each of the second plurality of grommet sets 48 are connected to the outer surface 11 laterally opposite one of the first plurality of grommet sets 47. The first plurality of drive cables 45 is connected to the first plurality of grommet sets 47, and the second plurality of drive cables 46 is connected to the second plurality of grommet sets 48.

Preferably, each of the plurality of grommet sets comprises a first grommet 402 and a second grommet 403. The first grommet 402 and the second grommet 403 are spaced apart from each other along a specified lateral arc on the lateral portion 12 of the outer surface 11. Furthermore, in order to connect the drive cables to the grommet sets, each of the drive cables comprise a pair of secondary cables for each grommet set the cable is attached to. A first secondary drive cable 400 is connected to the first grommet 402, and a second secondary drive cable 401 is connected to the second grommet 403. The linear positioning of the first secondary drive cable 400 and the second secondary drive cable 401 should be the reverse of the positioning of the first grommet 402 and the second grommet 403 relative to the drive cable. Therefore, the first secondary drive cable 400 is connected to the second grommet 403, and the second secondary drive cable 401 is connected to the first grommet 402. As a result, the first secondary drive cable 400 and the second secondary drive cable 401 criss-cross while traversing from the drive cable to the grommet set.

The preferred embodiment of the present invention includes a reflective mounting surface cover 6, wherein each of the at least one inflatable tube 1 rests atop the mounting surface 5. The reflective mounting surface cover 6 is placed between the at least one inflatable tube 1 and the mounting surface 5 in order to facilitate maximal sunlight exposure to the photovoltaic means 2.

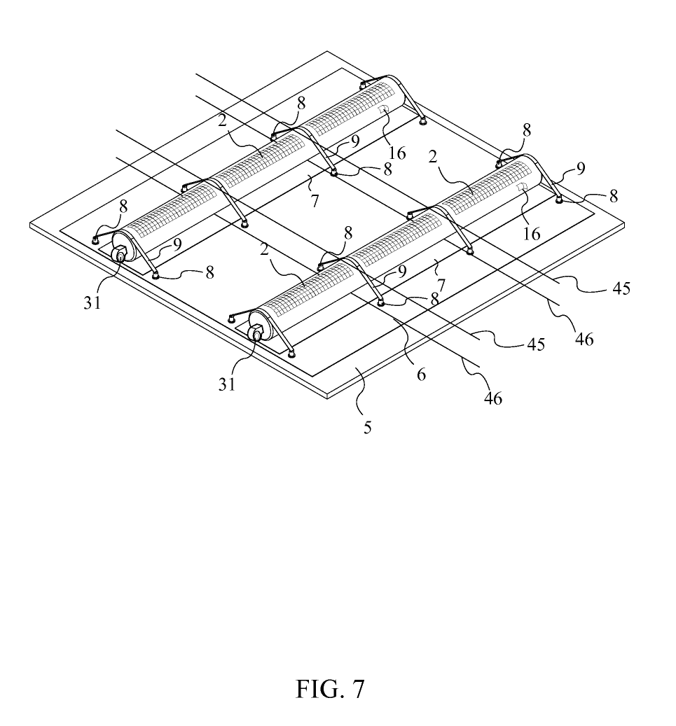

Referring to FIG. 7, in addition to the reflective mounting surface cover 6, the preferred embodiment additionally comprises at least one low-friction mounting surface cover 7. The quantity of the at least one mounting surface 5 cover matches the quantity of the at least one inflatable tube 1. Each of the at least one inflatable tube 1 is positioned atop one of the at least one low-friction mounting surface cover 7 in order to minimize friction between the at least one inflatable tube 1 and the mounting surface 5 during rotation of the at least one inflatable tube 1 by the tube rotation system 4. More particularly, the at least one low-friction mounting surface cover 7 is positioned between the at least one inflatable tube 1 and the reflective mounting surface cover 6. Each of the inflatable tubes 1 is positioned atop one of the low-friction mounting surface covers 7 opposite the reflective mounting surface cover 6 in order to minimize friction between the at least one inflatable tube 1 and the reflective mounting surface cover 6, or between the at least one inflatable tube 1 and the mounting surface 5, in the case that the reflective mounting surface cover 6 does not cover the entirety of the mounting surface 5, including surface area under the at least one low-friction surface cover.

An additional aspect of the present invention is means for securing the at least one inflatable tube 1 in place. To this end, a plurality of mounting surface 5 anchor pairs 8 is fastened to the mounting surface 5. Each of the mounting surface 5 anchor pairs 8 are positioned laterally across one of the at least one inflatable tube 1. Each of a plurality of straps 9 is connected between one of the mounting surface 5 anchor pairs 8 across the top of the at least one inflatable tube 1, applying downward force in order to hold the at least one inflatable tube 1 in place. Each of the plurality of straps 9 should be flat, flush with the outer surface 11 and made of a low-friction material, similar to the low-friction mounting surface covers 7, to accommodate rotation of the at least one inflatable tube 1. The anchors and corresponding straps 9 should be equally spaced out along the axial length of each of the at least one inflatable tube 1 for equal force distribution.

Each of the at least one inflatable tube 1 further comprises an air vent 16 as shown in FIG. 7 that traverses through from the outer surface 11 to the interior volume 13. The air vent 16 can be opened in order to vent air from the interior volume 13 if the temperature within the interior volume 13 is undesirably high. If the temperature within the interior volume 13 is too high, the efficiency of the photovoltaic means 2 is reduced. In the preferred embodiment, the air vent 16 is electronically connected to a thermostat 101 which operates and opens the air vent 16 if the temperature within the interior volume 13 reaches a certain threshold. Alternatively, instead of a thermostat 101 a temperature sensor connected to a controller 100 may be utilized to perform the same function.

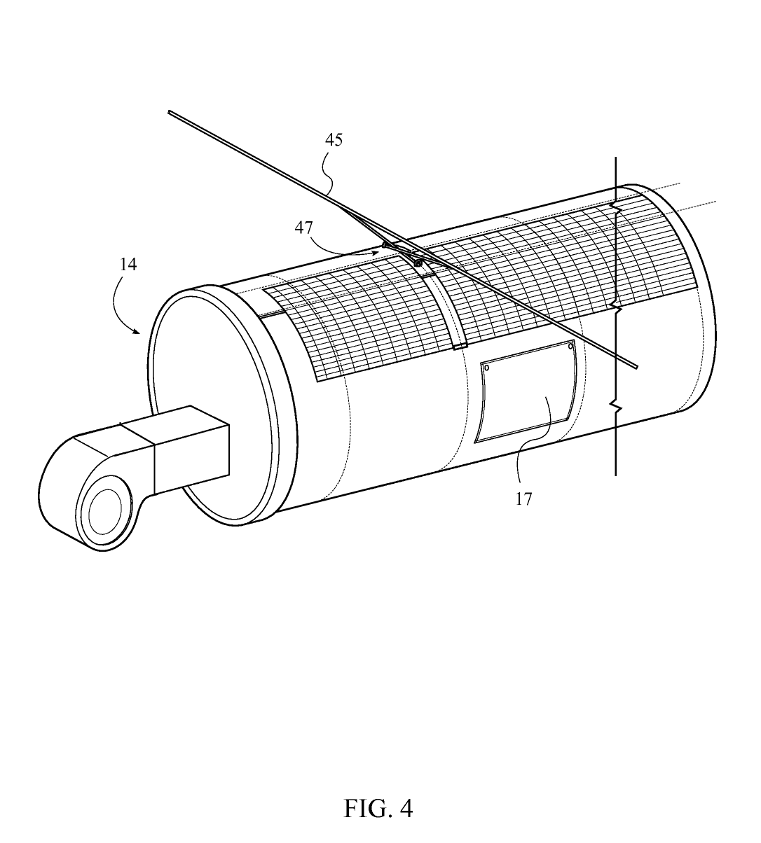

In the preferred embodiment each of the at least one inflatable tube 1 additionally comprises an access panel 17 large enough for a human to fit through, shown in FIG. 4. Similar to the air vent 16, the access panel 17 traverses from the outer surface 11 to the interior volume 13, and personnel may open the access panel 17 and enter the interior volume 13 in order to perform maintenance work or other operations.

Finally, the preferred embodiment of the present invention also comprises a controller 100 and a plurality of sensors 10. The controller 100 may be any electronic computing device that can receive electrical or electronic inputs which are manipulated or converted by a processor, rectifier, amplifier, or other electronic components in order to produce desired electrical or electronic outputs. The plurality of sensors 10 may include any relevant sensors 10 required to facilitate the operation of the present invention. More particularly, the plurality of sensors 10 comprises a wind-speed meter 102, or anemometer, and at least one air pressure sensor 103. Each of the plurality of sensors 10 is electronically connected to the controller 100. Each of the at least one air pressure sensor 103 is positioned within the interior volume 13 of one of the at least one inflatable tube 1. One or more of the at least one pressure sensor may also be positioned within the tube pressurization system 3 in order to monitor the operation of the tube pressurization system 3 for redundancy. The wind-speed meter 102 must be positioned outside the at least one inflatable tube 1 in order to measure the wind conditions in the environment. If a high wind speed condition is detected, measures should be taken to secure the at least one inflatable tube 1 against being disrupted by the wind. In particular, in a high wind speed condition the air pressure within each of the at least one inflatable tube 1 should be increased in order to make the tube structure rigid, and for the portion of the outer surface 11 in contact with the plurality of straps 9 to expand slightly and therefore increase the tension in the plurality of straps 9, thus making the structure of the at least one inflatable tube 1 more secure against the wind.

It should be noted that in an alternate embodiment of the present invention, the tube rotation system 4, the plurality of sensors 10, and the controller 100 may be omitted, as well as a single inflatable tube 1 being utilized. This is a bare-bones embodiment of the present invention which provides the same utility of supporting photovoltaic cells using inflatable tubing, but with a lesser effect and without the added value of being able to rotate the inflatable tube 1 for efficient sunlight collection.

Although the invention has been explained in relation to its preferred embodiment, it is to be understood that many other possible modifications and variations can be made without departing from the spirit and scope of the invention as hereinafter claimed.

What is claimed is:

1. A photovoltaic collector system utilizing inflatable tubing comprises:
at least one inflatable tube;
a photovoltaic means;
a tube pressurization system;
each of the inflatable tubes comprises an outer surface, a lateral portion, an interior volume, a first end, a second end;
the first end and the second end being positioned axially opposite each other along the lateral portion;
each of the photovoltaic cells being externally positioned about an exposure arc length of the lateral portion, wherein the exposure arc length is an arbitrary portion of the lateral portion desired to be exposed to sunlight; and
the tube inflation system being operatively connected to each of the at least one inflatable tube, wherein the tube inflation system supplies the interior volume of each of the at least one inflatable tube with air pressure.

2. The photovoltaic collector system utilizing inflatable tubing as claimed in claim 1 comprises:
the photovoltaic means comprises a plurality of flexible photovoltaic panels; and
the plurality of flexible photovoltaic panels being connected to the lateral portion of the outer surface along the exposure arc length, wherein the plurality of flexible photovoltaic panels are assembled prior to application to the at least one flexible tube.

3. The photovoltaic collector system utilizing inflatable tubing as claimed in claim 1 comprises:
the photovoltaic means being connected to the lateral portion of the outer surface along the exposure arc length, wherein the photovoltaic means are applied directly onto the at least one flexible tube without necessitating prior assembly of photovoltaic panels.

4. The photovoltaic collector system utilizing inflatable tubing as claimed in claim 1 comprises:
a controller, wherein the controller receives and processes electrical or electronic inputs in order to produce electrical or electronic outputs; and
the controller being electronically connected to the tube pressurization system and a tube rotation system.

5. The photovoltaic collector system utilizing inflatable tubing as claimed in claim 1 comprises:
a plurality of sensors;
the plurality of sensors comprises a wind-speed meter and at least one air pressure sensor;
each of the plurality of sensors being electronically connected to a controller;
each of the at least one air pressure sensor being positioned within the interior volume of one of the at least one inflatable tube; and
the wind-speed meter being positioned outside the at least one inflatable tube.

6. The photovoltaic collector system utilizing inflatable tubing as claimed in claim 1 comprises:
the at least one inflatable tube comprises a plurality of inflatable tubes;
each of the plurality of inflatable tubes being arranged in an array; and
the plurality of inflatable tubes being arranged parallel to each other within the array.

7. The photovoltaic collector system utilizing inflatable tubing as claimed in claim 1 comprises:
the tube inflation system comprises at least one air blower and a duct manifold;
the duct manifold comprises a primary manifold duct and at least one tube connection duct;
the at least one air blower being connected to the duct manifold, wherein the at least one air blower pressurizes the duct manifold by blowing air into the duct manifold;
the at least one tube connection duct being in fluid communication with the primary manifold duct; and
each of the at least one tube connection duct being in fluid communication with one of the at least one inflatable tube.

8. The photovoltaic collector system utilizing inflatable tubing as claimed in claim 1 comprises:
the tube inflation system comprises at least one air blower; and
each of the at least one air blower being ductedly connected to one of the at least one inflatable tube.

9. The photovoltaic collector system utilizing inflatable tubing as claimed in claim 1 comprises:
at least one one-way air valve; and
each of the at least one one-way air valves being connected between the tube inflation system and one of the at least one inflatable tube, wherein each of the at least one one-way air valve only allow air to enter the interior volume, while preventing air from leaving the interior volume.

10. The photovoltaic collector system utilizing inflatable tubing as claimed in claim 1 comprises:
a tube rotation system; and
the tube rotation system being connected to the outer surface of each of the at least one inflatable tube, wherein the tube rotation system allows each of the at least one inflatable tube to be axially rotated.

11. The photovoltaic collector system utilizing inflatable tubing as claimed in claim 10 comprises:
the tube rotation system comprises a first motor, a second motor, a first drive rod pair, a second drive rod pair, a first plurality of drive cables, a second plurality of drive cables;
the first plurality of drive cables being spooled between the drive rods of the first drive rod pair;
the second plurality of drive cables being spooled between the drive rods of the second drive rod pair;
the first motor being operatively connected to the first drive rod pair, wherein the first motor axially rotates one of the drive rods of the first drive rod pair;
the second motor being operatively connected to the second drive rod pair, wherein the second motor axially rotates one of the drive rods of the second drive rod pair;
the at least one inflatable tube being positioned between the first plurality of drive cables and the second plurality of drive cables, wherein the first plurality of drive cables are positioned above the at least one inflatable tube, and wherein the second plurality of drive cables is positioned below the at least one inflatable tube;
the at least one inflatable tube being positioned between the drive rods of the first drive rod pair and the drive rods of the second drive rod pair;
each of the first plurality of drive cables being externally connected to the lateral portion of one of the at least one inflatable tube; and
each of the second plurality of drive cables being externally connected to the lateral portion of one of the inflatable tubes laterally opposite one of the first plurality of drive cables.

12. The photovoltaic collector system utilizing inflatable tubing as claimed in claim 11 comprises:
the first drive rod pair and the second drive rod pair being oriented parallel to each of the at least one inflatable tube; and
the first plurality of drive cables and the second plurality of drive cables being oriented perpendicular and tangent to each of the at least one inflatable tube.

13. The photovoltaic collector system utilizing inflatable tubing as claimed in claim 11 comprises:
the tube rotation system further comprises a first plurality of grommet sets and a second plurality of grommet sets;
each of the first plurality of grommet sets being connected to the outer surface of one of the inflatable tubes;
each of the second plurality of grommet sets being connected to the outer surface of one of the inflatable tubes laterally opposite one of the first plurality of grommet sets;
the first plurality of drive cables being connected to the first plurality of grommet sets; and
the second plurality of drive cables being connected to the second plurality of grommet sets.

14. The photovoltaic collector system utilizing inflatable tubing as claimed in claim 13 comprises:
each of the plurality of grommet sets comprises a first grommet and a second grommet; and
the first grommet and the second grommet being spaced apart from each other along a specified lateral arc on the outer surface.

15. The photovoltaic collector system utilizing inflatable tubing as claimed in claim 1 comprises:
a reflective mounting surface cover; and
each of the at least one inflatable tube being positioned atop the reflective mounting surface cover, wherein the reflective mounting surface cover facilitates maximal sunlight exposure to the photovoltaic means.

16. The photovoltaic collector system utilizing inflatable tubing as claimed in claim 1 comprises:
At least one low-friction mounting surface cover; and
each of the at least one inflatable tube being positioned atop one of the at least one low-friction mounting surface cover, wherein the at least one low-friction mounting surface cover minimizes friction between the at least one inflatable tube and a mounting surface during rotation of the at least one inflatable tube by a tube rotation system, wherein the at least one inflatable tube are positioned atop the mounting surface.

17. The photovoltaic collector system utilizing inflatable tubing as claimed in claim 1 comprises:
a reflective mounting surface cover;
a plurality of low-friction mounting surface covers;
the reflective mounting surface cover being positioned on a mounting surface;
each of the plurality of low-friction mounting surface covers being positioned atop the reflective mounting surface cover; and
each of the inflatable tubes being positioned atop one of low-friction mounting surface covers opposite the reflective mounting surface cover, wherein the plurality of low-friction mounting surface covers minimizes friction between the at least one inflatable tube and the reflective mounting surface cover during rotation of the at least one inflatable tube by a tube rotation system.

18. The photovoltaic collector system utilizing inflatable tubing as claimed in claim 1 comprises:
a plurality of straps;
a plurality of mounting surface anchor pairs;
each of the mounting surface anchor pairs being fastened to a mounting surface, wherein each of the at least one inflatable tube rests atop the mounting surface;
each of the mounting surface anchor pairs being positioned laterally across one of the at least one inflatable tube; and
each of the plurality of straps being connected between one of the mounting surface anchor pairs atop one of the at least one inflatable tube.

19. The photovoltaic collector system utilizing inflatable tubing as claimed in claim 18 comprises:
each of the plurality of straps being made of a low-friction material.

20. The photovoltaic collector system utilizing inflatable tubing as claimed in claim 1 comprises:
each of the at least one inflatable tube further comprises an air vent; and
the air vent traversing through from the outer surface to the interior volume, wherein the air vent can be opened in order to vent air from the interior volume if the temperature within the interior volume is undesirably high.

21. The photovoltaic collector system utilizing inflatable tubing as claimed in claim 20 comprises:
the air vent being electronically connected to a thermostat, wherein the air vent is operated by the thermostat if the temperature within the interior volume reaches a certain threshold.

22. The photovoltaic collector system utilizing inflatable tubing as claimed in claim 1 comprises:
each of the at least one inflatable tube comprises an access panel; and
the access panel traversing from the outer surface to the interior volume, wherein the access panel may be opened in order to allow maintenance access to the interior volume.
